(19) United States
(12) Patent Application Publication
(10) Pub. No.: US 2023/0365152 A1
(43) Pub. Date: Nov. 16, 2023

(54) DRIVING ASSISTANCE DEVICE

(71) Applicant: TOYOTA JIDOSHA KABUSHIKI KAISHA, Toyota-shi Aichi-ken (JP)

(72) Inventors: Takashi UNIGAME, Nagoya-shi Aichi-ken (JP); Yusuke ISHIMATSU, Kyoto-shi Kyoto-hu (JP)

(73) Assignee: TOYOTA JIDOSHA KABUSHIKI KAISHA, Toyota-shi Aichi-ken (JP)

(21) Appl. No.: 18/142,851

(22) Filed: May 3, 2023

(30) Foreign Application Priority Data
May 10, 2022 (JP) 2022-077527

(51) Int. Cl. B60W 50/14; B60W 30/09

(52) U.S. Cl. CPC B60W 50/14; B60W 30/09; B60W 2420/54; B60W 2420/52; B60W 2050/146; B60W 2050/143

(57) ABSTRACT

A driving assistance device includes: a radar provided in a rear portion of an own vehicle, and which transmits a radio wave to a predetermined detection region directed toward a rear side and a lateral side of the own vehicle, receives the radio wave reflected in the detection region, and detects a target around the own vehicle based on the received radio wave; a control device which executes driving assistance control including at least one of alert directed to a driver or braking of the own vehicle when a target is detected by the radar device; and a door opening detection device which detects whether a predetermined door, which possibly enters the detection region when the door is opened, is opened among doors of the own vehicle. The control device suppresses the driving assistance control when the opening of the door is detected by the door opening detection device.

### CROSS-REFERENCE TO RELATED APPLICATIONS

This application claims priority to Japanese Patent Application No. 2022-077527 filed on May 10, 2022, which is incorporated herein by reference in its entirety including the description, claims, drawings, and abstract.

### BACKGROUND

### 1. Technical Field

The present disclosure relates to a driving assistance device which is mounted to a vehicle, and which detects a target existing around the vehicle and executes driving assistance control (predetermined control for increasing safety of the vehicle) in accordance with a result of the detection.

### 2. Description of the Related Art

There has been proposed a driving assistance device (hereinafter referred to as “related-art device”) which is mounted to an own vehicle, and which detects a target existing around the vehicle and executes predetermined control for increasing safety of the vehicle in accordance with a result of the detection (for example, see Japanese Patent Translation Publication No. 2008-531388). The related-art device includes a transmission device, a reception device, a control device, and the like. The transmission device includes a transmission antenna which transmits a radio wave to a periphery (for example, a predetermined detection region extending toward a rear side and a lateral side (diagonally rear side in plan view)) of the own vehicle. This radio wave is reflected on a target (such as another vehicle, a pedestrian, a guard rail, or a pole) existing on the diagonally rear side of the own vehicle. The reception device includes a reception antenna which receives the reflected wave and outputs a signal (hereinafter referred to as “reflected wave signal”) representing this reflected wave. The control device calculates positions (distances from the own vehicle, directions as viewed from the own vehicle, and the like) of a plurality (several hundreds) of reflection points (reflection points of the radio waves) based on the reflected wave signals, and detects a target existing around the own vehicle based on results of the calculation. Moreover, the control device executes driving assistance control such as alert and braking based on this detection results. Those functions are hereinafter referred to as “rear cross traffic alert (RCTA) function” and “rear cross traffic brake (RCTB) function.”

The related-art device is mounted to, for example, a corner portion of a bumper cover in a rear portion of the own vehicle. In this case, under a state in which a door (for example, a slide door of an entrance/exit for a rear seat) in the rear portion of the own vehicle is open, a part of this door may enter the above-mentioned detection region. In this case, the radio wave transmitted from the transmission antenna is reflected on the slide door. In the control device, it is difficult to distinguish the radio wave reflected on this slide door and the radio wave reflected on a target which is originally to be detected (such as another vehicle, a pedestrian, a guard rail, or a pole) from each other. As a result, there is fear in that unnecessary driving assistance control may be executed.

### SUMMARY

One object of the present disclosure is to provide a driving assistance device which suppresses execution of unnecessary driving assistance control.

In order to solve the above-mentioned problem, according to at least one embodiment of the present disclosure, there is provided a driving assistance device (1) including: a radar device (20) which is provided in a rear portion of an own vehicle, and is configured to transmit a radio wave to a predetermined detection region directed toward a rear side and a lateral side of the own vehicle, receive the radio wave reflected in the predetermined detection region, and to detect a target around the own vehicle based on the received radio wave; a control device (10) configured to execute driving assistance control including at least one of alert directed to a driver or braking of the own vehicle when a target is detected by the radar device; and a door opening detection device (30, 40) configured to detect whether a predetermined door (DRL, DRR), which possibly enters the predetermined detection region when the predetermined door is opened, is opened among doors of the own vehicle, wherein the control device is configured to suppress the driving assistance control when the opening of the predetermined door is detected by the door opening detection device.

For example, when the opening of the predetermined door is detected by the door opening detection device, the control device suppresses the driving assistance control by limiting the detection region of the radar device.

With this configuration, the execution of the driving assistance control which is not originally required (the driving assistance control caused by the detection of the open door by the radar device) is suppressed.

In the driving assistance device according to one aspect of the present disclosure, when the opening of the predetermined door is detected by the door opening detection device, the control device is configured to suppress the driving assistance control by executing the driving assistance control based on the radio wave reflected in a second region which is included in the predetermined detection region, and is other than a first region which the predetermined door has entered.

In this aspect, a reception region of the reflected wave is limited (the radio wave reflected in the first region is neglected). With this configuration, the driving assistance control can relatively easily be suppressed.

In the driving assistance device according to another aspect of the present disclosure, when the opening of the predetermined door is detected by the door opening detection device, the control device is configured to suppress the driving assistance control by controlling the radar device such that the radio wave is transmitted to a second region which is included in the predetermined detection region, and is other than a first region which the predetermined door has entered.

In this aspect, a transmission region (radiation range) of the radio waves is limited. With this configuration, the driving assistance control can relatively easily be suppressed.

In the driving assistance device according to still another aspect of the present disclosure, the door opening detection device includes an ultrasonic sensor.

In a vehicle including the ultrasonic sensor as the device which detects a peripheral target (such as another vehicle and a pedestrian), it is possible to detect the open or closed state of the predetermined door through use of this ultrasonic sensor. With this configuration, it is not required to provide a dedicated device for detecting the open or closed state of the predetermined door.

In the driving assistance device according to yet another aspect of the present disclosure, the predetermined door is a slide door.

In design of a vehicle (determination of an exterior of a vehicle), there is a case in which the entry of the slide door into the detection region of the radar device is required to be allowed. With this configuration, the execution of the driving assistance control which is caused by the detection of the open slide door by the radar device is suppressed.

### BRIEF DESCRIPTION OF THE DRAWINGS

FIG. 1 is a block diagram of a driving assistance device according to at least one embodiment of the present disclosure.

FIG. 2A is a perspective view of a vehicle to which the driving assistance device of FIG. 1 is applied as viewed from a rear left side.

FIG. 2B is a perspective view of the vehicle to which the driving assistance device of FIG. 1 is applied as viewed from a rear right side.

FIG. 3 is a plan view of the vehicle to which the driving assistance device of FIG. 1 is applied.

FIG. 4 is a block diagram of a radar.

FIG. 5 is a flowchart of a computer program which implements a function of limiting a detection region of the radar.

FIG. 6 is a block diagram of a radar in a modification example of the present disclosure.

### DESCRIPTION OF THE EMBODIMENTS

(Overview)

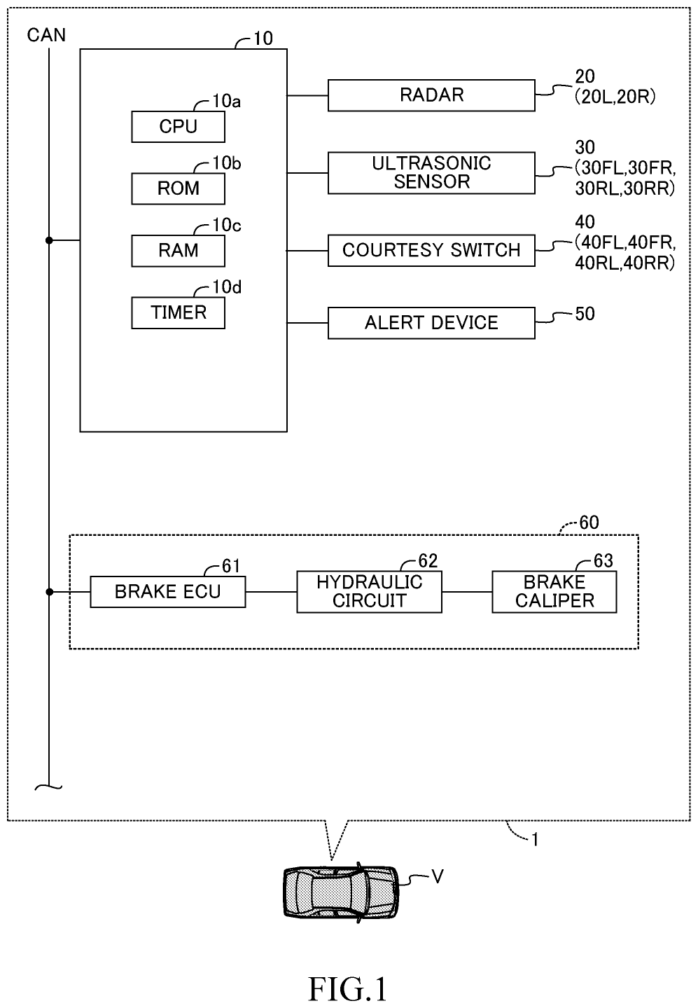

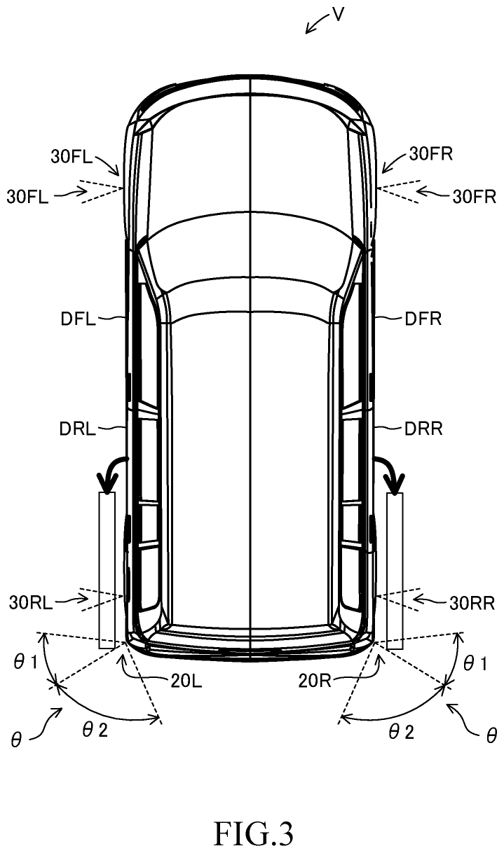

As illustrated in FIG. 1 to FIG. 3, a driving assistance device 1 according to at least one embodiment of the present disclosure is mounted to a vehicle V. Doors DFL and DFR are provided to entrances/exits for front seats of the vehicle V. Doors DRL and DRR are provided to entrances/exits for rear seats of the vehicle V. The doors DFL and DFR are swing doors. The doors DRL and DRR are slide doors. The doors DRL and DRR can slide in a vehicle front-and-rear direction. The doors DRL and DRR slide backward to open from a state in which the doors DRL and DRR are closed (see FIG. 3). The driving assistance device 1 has an RCTA function and an RCTB function. The driving assistance device 1 may has only one of the RCTA function and the RCTB function.

(Specific Configuration)

As illustrated in FIG. 1, the driving assistance device 1 includes a driving assistance ECU 10, a radar 20, an ultrasonic sensor 30, a courtesy switch 40, an alert device 50, and a braking device 60.

The driving assistance ECU 10 includes a microcomputer including, for example, a CPU 10a, a ROM 10b, a RAM 10c, and a timer 10d. As used herein, “ECU” means an electronic control unit, and the ECU includes a microcomputer including, for example, a CPU, a ROM, a RAM, and a timer. The CPU implements various functions by executing instructions stored in the ROM.

The driving assistance ECU 10 is connected to other ECUs (for example, brake ECU 61 described later) via a controller area network (CAN) in a manner that enables information to be transmitted and received to and from each other.

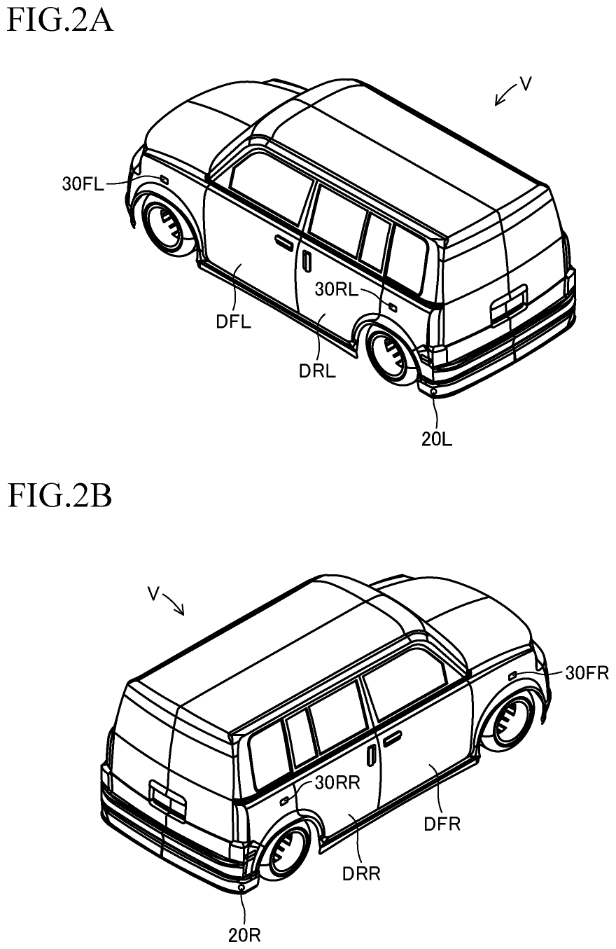

The radar 20 is formed of radars 20L and 20R provided in left and right corner portions of a rear bumper cover of the vehicle V, respectively (see FIG. 2A and FIG. 2B). The radar 20 acquires information on 3D objects existing around the vehicle V. That is, for example, the radar 20 acquires information on moving objects such as a vehicle (another vehicle), a pedestrian, and a bicycle and fixed objects such as a guard rail and a pole.

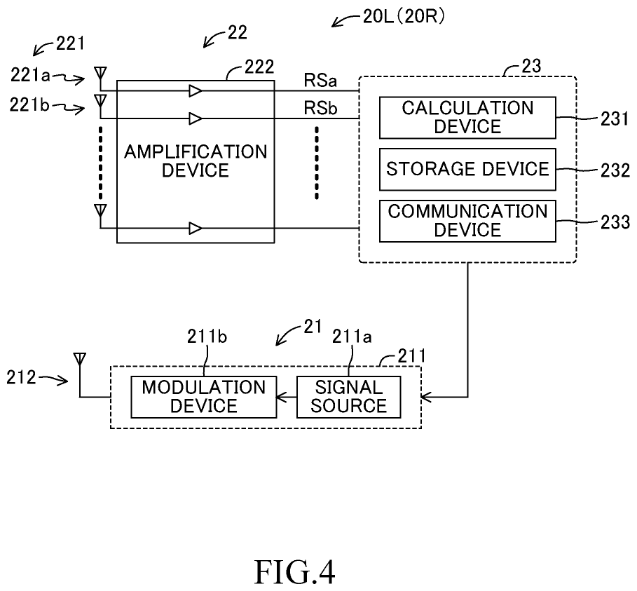

A configuration of the radar 20L and a configuration of the radar 20R are the same. Thus, the configuration of the radar 20L is described below, and description of the configuration of the radar 20R is omitted. As illustrated in FIG. 4, the radar 20L includes a transmission device 21, a reception device 22, and a control device 23.

The transmission device 21 includes a transmitter 211 and a transmission antenna 212. The transmitter 211 includes a signal source 211a which outputs a signal (for example, a sine wave) having a constant frequency and a modulation device 211b which changes the frequency of the signal output from this signal source 211a at a predetermined cycle. The transmission antenna 212 is provided to the corner portion of the rear bumper cover of the vehicle V. A center axis of the transmission antenna 212 is directed toward a diagonally rear left side (diagonally rear right side in the case of the radar 20R) in plan view of the vehicle V. The transmission antenna 212 transmits the signal (modulated signal) output from the modulation device 211b from the vehicle V toward a rear side and a lateral side (diagonally rear side). The radio wave transmitted from the transmission antenna 212 is reflected on a target positioned around the vehicle V. This reflected wave is received by the reception device 22 (reception antenna 221) described below.

The reception device 22 includes the reception antenna 221 and an amplification device 222. The reception antenna 221 is directed to the diagonally rear left side (diagonally rear right side in the case of the radar 20R) of the vehicle V in the corner portion of the rear bumper cover of the vehicle V in the same manner as in the transmission antenna 212. The reception antenna 221 is formed of a plurality of antenna elements 221a, 221b, . . . each of the antenna elements 221a, 221b, . . . receives the reflected wave from a target positioned in a predetermined range (angle range) having a center axis of this antenna element as a reference, and outputs one of reflected wave signals RSa, RSb, . . . representing this reflected wave. Each of the antenna elements 221a, 221b, . . . is configured to have high reception sensitivity for the reflected wave from a reflection point positioned in the above-mentioned predetermined range. The antenna elements 221a, 221b, . . . are directed to directions different from one another. As a result, a wide field of view (FOV (detection range θ)) is achieved, and high angular resolutions (resolutions in a horizontal direction and a vertical direction) are achieved. That is, the detection range (reception range) of each of the antenna elements 221a, 221b, . . . is relatively narrow, but the plurality of antenna elements 221a, 221b, . . . are arranged such that the detection ranges thereof are displaced from each other, to thereby achieve a wide detection range θ of the reception antenna 221 (radar 20L) as a whole. Moreover, it is possible to detect direction of the target based on amplitudes, phases, and the like of the reflected wave signals RSa, RSb, . . .

As illustrated in FIG. 3, rear portions of the doors DRL and DRR enter the detection regions θ of the radars 20L and 20R when the doors DRL and DRR are fully opened (at the opening degree of 100%). In the following description, a region which is included in the detection region θ, and which each of the doors DRL and DRR has entered (angle range in which the transmitted wave and the reflected wave are blocked by the door) is referred to as “first region θ1,” and the remaining region of the detection region θ is referred to as “second region θ2.”

With reference again to FIG. 4, the amplification device 222 amplifies the reflected wave signal output from each of the antenna elements 221a, 221b, . . . , and supplies the amplified reflected wave signal to the control device 23.

The control device 23 includes a calculation device 231, a storage device 232 (RAM, ROM, and the like), and a communication device 233, for example. The calculation device 231 is connected to the driving assistance ECU 10 via the communication device 233. The calculation device 231 executes a target detection program (not shown) at a predetermined cycle, to thereby sequentially acquire the reflected wave signals RSa, RSb, . . . from the amplification device 222. The calculation device 231 analyzes the reflected wave signals RSa, RSb, . . . , to thereby detect a position (direction and distance with respect to the own vehicle) of a target existing in the diagonally rear left side (the diagonally rear right side in the case of the radar 20R) of the vehicle V. After that, the calculation device 231 transmits results of the detection to the driving assistance ECU 10 via the communication device 233.

The ultrasonic sensor 30 includes ultrasonic sensors 30FL and 30RL provided on a left side surface of the vehicle V and ultrasonic sensors 30FR and 30RR provided on a right side surface of the vehicle V (see FIG. 2A and FIG. 2B). The ultrasonic sensor 30FL is arranged above a left front tire. The ultrasonic sensor 30RL is arranged above a left rear tire. The ultrasonic sensor 30FR is arranged above a right front tire. The ultrasonic sensor 30RR is arranged above a right rear tire.

Each of the ultrasonic sensors 30FL, 30RL, 30FR, and 30RR transmits an ultrasonic wave in a pulsed manner (intermittently) toward the lateral side of the vehicle V, and receives the ultrasonic wave (reflected wave) reflected by a target. The ultrasonic censors 30FL, 30RL, 30FR, and 30RR calculate distances Δ30FL, Δ30RL, Δ30FR, and Δ30RR to the target, respectively, based on a period of time from the transmission of the ultrasonic wave to the reception of the reflected wave, and transmits those distances to the driving assistance ECU 10 as detection results. The ultrasonic sensors 30FL, 30RL, 30FR, and 30RR can precisely detect existence of a 3D object at a relatively short distance. When a target does not exist in a detectable range of each ultrasonic sensor, each ultrasonic sensor transmits a predetermined maximum value to the driving assistance ECU 10 as the detection result. As illustrated in FIG. 3, when the door DRL (DRR) is open, this door is positioned on a left side (right side) of the ultrasonic sensor 30RL (30RR). Thus, the ultrasonic sensor 30RL (30RR) detects the distance to this door DRL (DRR).

The courtesy switch 40 is a well-known normally-open switch (momentary switch). The courtesy switch 40 is formed of courtesy switches 40FL, 40RL, 40FR, and 40RR arranged in respective peripheral regions (frame of the vehicle V) of the entrances/exits to which the doors DFL, DRL, DFR, and DRR are provided. When the door DFL (or DRL, DFR, or DRR) is open, a movable contact of the courtesy switch 40FL (or 40RL, 40FR, or 40RR) is apart from a fixed contact. That is, the courtesy switch 40FL (or 40RL, 40FR, or 40RR) is in an OFF state. When the door DFL (or DRL, DFR, or DRR) is closed, the movable contact of the courtesy switch 40FL (or 40RL, 40FR, or 40RR) is pressed by the door DFL (or DRL, DFR, or DRR), and hence is in abutment against the fixed contact. That is, the courtesy switch 40FL (or 40RL, 40FR, or 40RR) is in an ON state. When each door is ajar, each courtesy switch is in the OFF state. Here, the ultrasonic sensor 30 and the courtesy switch 40 correspond to a door opening detection device in the present disclosure.

With reference again to FIG. 1, the alert device 50 includes a display device formed of a liquid crystal display, an LED, and the like and a sound reproduction device formed of a speaker, an amplification device, and the like.

The braking device 60 applies a braking force to the wheels. The braking device 60 includes the brake ECU 61, a hydraulic circuit 62, and a brake caliper 63. The hydraulic circuit 62 includes, for example, a reservoir, an oil pump, various valve devices, and a hydraulic sensor (which are not shown). The brake caliper 63 is a hydraulic actuator including a cylinder and a piston. When oil is supplied to the cylinder, the piston is pushed out of the cylinder. A brake pad is arranged at the tip of the piston, and the brake pad is pressed against a brake disc. The brake ECU 61 receives a brake pressure control signal from the driving assistance ECU 10. The brake ECU 61 transmits a hydraulic pressure control signal to the hydraulic circuit 62 in accordance with the brake pressure control signal acquired from the driving assistance ECU 10. The hydraulic circuit 62 adjusts the hydraulic pressure in the cylinder of the brake caliper 63 in accordance with the hydraulic pressure control signal acquired from the brake ECU 61. In this way, the braking force of the wheels (brake discs) by the brake caliper 63 is controlled.

(RCTA Function and RCTB Function)

Description is now given of the rear cross traffic alert function (RCTA function) and the rear cross traffic brake function (RCTB function) of the driving assistance device 1. The driving assistance ECU 10 acquires, from the radar 20, the detection results of a target existing on the diagonally rear left side of the vehicle V, and a target existing on the diagonally right rear side of the vehicle V. When a target exists on at least one of the diagonally rear left side or the diagonally rear right side of the vehicle V, the driving assistance ECU 10 controls the alert device 50 such that predetermined information (for example, video, audio, and the like) is presented to the driver (alert control). Moreover, the driving assistance ECU 10 controls the braking device 60 such that the vehicle V is braked (braking control). For example, the driving assistance ECU 10 executes the alert control when the distance between the vehicle V and the target is equal to or shorter than a first distance, and executes the braking control when the vehicle V approaches the target, and hence the distance therebetween becomes equal to or shorter than a second distance shorter than the first distance.

However, when the door DRL or DRR is open, the driving assistance ECU 10 neglects a part of the detection results acquired from the radar 20, to thereby suppress the driving assistance control (alert control and braking control) (cause the driving assistance control to fall back). That is, the driving assistance ECU 10 limits the execution condition of the alert control and the braking control (driving assistance control).

Specifically, the driving assistance ECU 10 neglects the information on a target positioned in the first region θ1 out of the detection results of the radar 20L when the following condition A is satisfied (when the door DRL is open, and hence is interfering with the detection region θ). That is, the driving assistance ECU 10 executes the alert control and the braking control when a target exists in the second region θ2 of the radar 20L. In other words, the detection region θ (=θ1+θ2) of the radar 20L is narrowed, and hence is limited to the second region θ2 (region with which the door DRL is not interfering).

(Condition A)

The courtesy switch 40RL is in the OFF state, the distance Δ30FL exceeds a threshold value ThFL, and the distance Δ30RL is equal to or shorter than a threshold value ThRL.

In this condition, the threshold value ThRL is slightly longer than a distance to the door DRL detected by the ultrasonic sensor 30RL when the door DRL is open (FIG. 3).

Further, the driving assistance ECU 10 neglects the information on a target positioned in the first region θ1 out of the detection results of the radar 20R when the following condition B is satisfied (when the door DRR is open, and hence is interfering with the detection region θ). That is, the driving assistance ECU 10 executes the alert control and the braking control when a target exists in the second region θ2 of the radar 20R. In other words, the detection region θ (=θ1+θ2) of the radar 20R is narrowed, and hence is limited to the second region θ2 (region with which the door DRR is not interfering).

(Condition B)

The courtesy switch 40RR is in the OFF state, the distance Δ30FR exceeds a threshold value ThFR, and the distance Δ30RR is equal to or shorter than a threshold value ThRR.

In this condition, the threshold value ThRR is slightly longer than a distance to the door DRR detected by the ultrasonic sensor 30RR when the door DRR is open (FIG. 3).

When the condition A (condition B) is satisfied, but the condition B (condition A) is not satisfied, only the detection region θ of the radar 20L (20R) is limited to the second region θ2, and the detection region θ of the radar 20R (20L) is not limited.

As described above, the driving assistance ECU 10 determines the open or closed states of the doors DRL and DRR based on the ON or OFF states of the courtesy switches 40 and the detection results of the ultrasonic sensors 30. For example, there is a case (for example, the ajar state) in which the door DRL (DRR) is not fully open even when the courtesy switch 40RL (40RR) is in the OFF state. In this case, the door DRL (DRR) has not entered the detection region θ of the radar 20L (20R), and hence it is not required to narrow the detection region θ. Moreover, for example, when another vehicle is parked adjacent to the own vehicle, or when the own vehicle has entered a narrow road, it is difficult to distinguish, only based on the detection result of the ultrasonic sensor 30RL (30RR) in the rear portion, the open door DRL (DRR) and a target such as another vehicle (target other than door DRL (DRR)) from each other. Thus, in the at least one embodiment, in addition to the ultrasonic sensor 30RL (30RR) in the rear portion, the detection result of the ultrasonic sensor 30FL (30FR) in the front portion is used to determine the open or closed state of the door DRL (DRR). That is, in the at least one embodiment, the ultrasonic sensor 30FL (30FR) in the front portion is used to determine the presence or absence of a target adjacent to the own vehicle. In other words, the driving assistance ECU 10 determines that an adjacent target does not exist when the distance Δ30FL (Δ30FR) detected by the ultrasonic sensor 30FL (30FR) exceeds the threshold value ThFL (ThFR). In this state, when the distance Δ30RL (Δ30RR) detected by the ultrasonic sensor 30RL (30RR) in the rear portion is equal to or shorter than the threshold value ThRL (ThRR), the driving assistance ECU 10 determines that the door DRL (DRR) is opened to such a degree that the door DRL (DRR) has entered the detection region θ. After that, in this case, the driving assistance ECU 10 limits the detection region θ of the radar 20L (20R) to the second region θ2.

As described above, the driving assistance ECU 10 changes the detection regions θ of the radars 20L and 20R in accordance with the determination results for the open or closed states of the doors DRL and DRR. That is, the driving assistance ECU 10 changes an execution condition for the driving assistance control. Description is now given of a computer program P executed by a CPU 10a (hereinafter simply referred to as “CPU”) of the driving assistance ECU 10 in order to implement this function. The computer program P is formed of a program PL for implementing a function of changing the detection region θ of the radar 20L in accordance with the determination result for the open or closed state of the door DRL and a program PR for implementing a function of changing the detection region θ of the radar 20R in accordance with the determination result for the open or closed state of the door DRR. The driving assistance ECU 10 executes the programs PL and PR at a predetermined cycle. Configurations of the program PL and the program PR are the same. Thus, the program PL is described below, and description of the program PR is omitted.

The CPU starts executing the program PL from Step 100, and then advances the process to Step 101.

In Step 101, the CPU determines whether or not the courtesy switch 40RL is in the OFF state. When the courtesy switch 40RL is in the OFF state (Yes in Step 101), the CPU advances the process to Step 102. Meanwhile, when the courtesy switch 40RL is in the ON state (Yes in Step 101), the CPU advances the process to Step 105 described later.

In Step 102, the CPU determines whether or not the distance Δ30FL exceeds the threshold value ThFL. When the distance Δ30FL exceeds the threshold value ThFL (Yes in Step 102), the CPU advances the process to Step 103. Meanwhile, when the distance Δ30FL does not exceed the threshold value ThFL (No in Step 102), the CPU advances the process to Step 105.

In Step 103, the CPU determines whether or not the distance Δ30RL is equal to or shorter than the threshold value ThRL. When the distance Δ30RL is equal to or shorter than the threshold value ThRL (Yes in Step 103), the CPU advances the process to Step 104. Meanwhile, when the distance Δ30RL exceeds the threshold value ThRL (No in Step 104), the CPU advances the process to Step 105.

In Step 104, the CPU limits the detection region θ of the radar 20L to the second region θ2. After that, the CPU advances the process to Step 106, and finishes the program PL.

When the process is advanced from Step 101, Step 102, or Step 103 to Step 105, the CPU releases the limit on the detection region θ of the radar 20L. That is, the CPU sets the detection region θ to the first region θ1 and the second region θ2. After that, the CPU advances the process to Step 106.

(Effects)

As described above, the CPU determines the open or closed state of the door DRL (DRR) based on not only the ON or OFF state of the courtesy switch 40RL (40RR), but also the detection results of the ultrasonic sensors 30FL and 30RL (30FR and 30RR). Specifically, the CPU determines whether or not the distance Δ30FL (Δ30FR), which is the detection result of the ultrasonic sensor 30FL (30FR) in the front portion, exceeds the threshold value ThFL (ThFR). Moreover, the CPU determines whether or not the distance Δ30RL (Δ30RR), which is the detection result of the ultrasonic sensor 30RL (30RR) in the rear portion, is equal to or shorter than the threshold value ThRL (ThRR). That is, the CPU determines whether or not a target exists on the left side (right side) of the front portion and the rear portion of the vehicle V based on the distances Δ30FL and Δ30RL (Δ30FR and Δ30RR).

The state in which the distance Δ30FL (Δ30FR) exceeds the threshold value ThFL (ThFR) and the distance Δ30RL (Δ30RR) is equal to or shorter than the threshold value ThRL (ThRR) is the state in which a target does not exist on the left side (right side) of the front portion, and a target exists on the left side (right side) in the rear portion. In this state, the door DRL (DRR) is open, and the detection result of the ultrasonic sensor 30RL (30RR) is highly likely to represent the distance to the door DRL (DRR). Moreover, the door DRL (DRR) has entered the first region θ1 of the detection region θ of the radar 20L (20R) when the door DRL (DRR) is opened to this degree. Thus, in this situation, the CPU limits the detection region θ of the radar 20L (20R) to the second region θ2. In other words, the CPU does not use the reception antennas directed to the first region θ1 and the reflected wave signals corresponding thereto. That is, the CPU executes the driving assistance control (alert control and braking control) based on only the radio waves (radio waves of the radar 20L (20R)) reflected on a target different from the door DRL (DRR). In this way, the execution of the driving assistance control which is not originally required (the driving assistance control based on the radio waves reflected on the open door DRL (DRR)) is suppressed.

The present disclosure is not limited to the at least one embodiment described above, and various modification examples can be adopted within the scope of the present disclosure as described below.

<Modification Example 1>

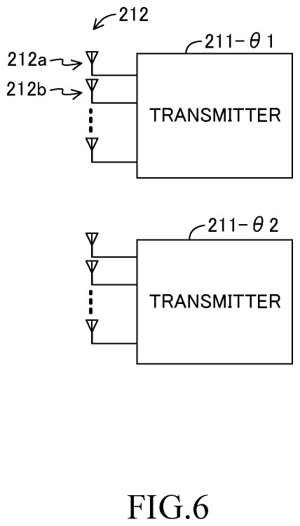

In the at least one embodiment described above, the reception region of the reflected waves of the radar 20L (20R) is limited to the second region θ2 in the state A (B). In place of this configuration, a transmission region (radiation range) of the radio waves may be limited to the second region θ2 in the state A (B). In some embodiments, the transmission antenna 212 may be formed of a plurality of antenna elements 212a, 212b, . . . (see FIG. 6) in the same manner as in the reception antenna 221. Some of the antenna elements 212a, 212b, . . . are arranged to direct toward the first region θ1, and the remaining antenna elements are arranged to direct toward the second region θ2. Moreover, it is only required that the radio waves emitted from the antenna elements directed toward the first region θ1 and the radio waves emitted from the antenna elements directed toward the second region θ2 be able to individually be controlled. For example, it is only required that the transmitter 211 be formed of a transmitter 211-θ1 corresponding to the first region θ1 and a transmitter 211-θ2 corresponding to the second region θ2.

<Modification Example 2>

As the device for detecting the open or closed state of the door DRL (DRR), in place of the ultrasonic sensor 30RL (30RR), there may be used a switch arranged such that the switch is in an ON state when the door opening degree is 100%, and is in an OFF state otherwise. For example, this switch may be built into a door latch device which holds the opening degree of the door DRL (DRR) at 100%. In this case, the courtesy switch 40RL (40RR) is not required for the driving assistance device 1.

<Modification Example 3>

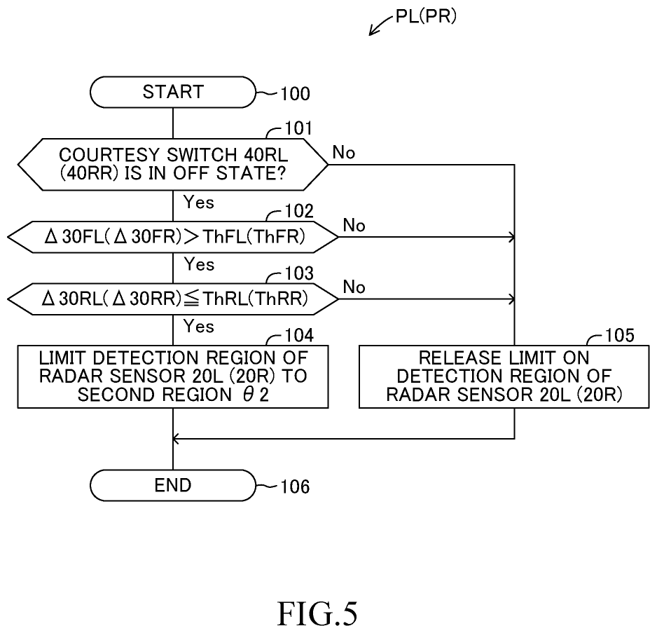

The open or closed state of the door DRL (DRR) may be determined based on only the ON or OFF state of the courtesy switch 40RL (40RR). In this case, it is only required to skip Step 102 and Step 103 of the program PL (PR) of FIG. 5. According to this modification example, the configuration of the driving assistance device 1 and the program P can be simplified.

<Modification Example 4>

The above-mentioned example is the example in which the doors in the rear portion of the vehicle V interfere with the detection regions of the radars 20L and 20R, but the present disclosure can be applied also to a case in which another door interferes with the detection region of the radar.

What is claimed is:

1. A driving assistance device, comprising:
a radar device which is provided in a rear portion of an own vehicle, and is configured to transmit a radio wave to a predetermined detection region directed toward a rear side and a lateral side of the own vehicle, receive the radio wave reflected in the predetermined detection region, and to detect a target around the own vehicle based on the received radio wave;
a control device configured to execute driving assistance control including at least one of alert directed to a driver or braking of the own vehicle when a target is detected by the radar device; and
a door opening detection device configured to detect whether a predetermined door, which possibly enters the predetermined detection region when the predetermined door is opened, is opened among doors of the own vehicle,
wherein the control device is configured to suppress the driving assistance control when the opening of the predetermined door is detected by the door opening detection device.

2. The driving assistance device according to claim 1, wherein, when the opening of the predetermined door is detected by the door opening detection device, the control device is configured to suppress the driving assistance control by executing the driving assistance control based on the radio wave reflected in a second region which is included in the predetermined detection region, and is other than a first region which the predetermined door has entered.

3. The driving assistance device according to claim 1, wherein, when the opening of the predetermined door is detected by the door opening detection device, the control device is configured to suppress the driving assistance control by controlling the radar device such that the radio wave is transmitted to a second region which is included in the predetermined detection region, and is other than a first region which the predetermined door has entered.

4. The driving assistance device according to claim 1, wherein the door opening detection device includes an ultrasonic sensor.

5. The driving assistance device according to claim 1, wherein the predetermined door is a slide door.

6. The driving assistance device according to claim 2, wherein the door opening detection device includes an ultrasonic sensor.

7. The driving assistance device according to claim 3, wherein the door opening detection device includes an ultrasonic sensor.
